(19) United States
(12) Patent Application Publication
(10) Pub. No.: US 2009/0115633 A1
(43) Pub. Date: May 7, 2009

(54) METHODS AND SYSTEMS FOR AUTOMATED WARNING DEVICE

(76) Inventors: Brian D. Lawry, Erie, PA (US); Wolfgang Daum, Erie, PA (US)

Correspondence Address: JOHN S. BEULICK (12729 +2000);ARMSTRONG TEASDALE LLP, ONE METROPOLITAN SQUARE, SUITE 2600, SAINT LOUIS, MO, 63102-2740, US

(21) Appl. No.: 11/934,614

(22) Filed: Nov. 2, 2007

(51) Int. Cl. G08G 9/00

(52) U.S. Cl. 340/936; 340/988; 340/435

(57) ABSTRACT

Methods and systems for automatically sounding a vehicle warning are provided. The method includes determining when the vehicle is within a predetermined distance to a warning area, and determining a speed of approach of the vehicle to the warning area. The method also includes determining an initiation point to activate the vehicle warning based on the speed of approach of the vehicle, and sounding the vehicle warning at the initiation point.

### BACKGROUND OF THE INVENTION

This invention relates generally to automated railroad operation, and more particularly, to methods and systems for automatically activating train warning devices.

At least some known collisions between trains and vehicles occur at public and private highway-rail grade crossings. A portion of these collisions occur at grade crossings with active warning devices such as bells, flashing lights, and/or gates. The Federal Railroad Administration (FRA) has determined that the sounding of train horns significantly reduces accidents at grade crossings. However, some state and local governments enacted legislation prohibiting the use of horns at certain locations and/or times.

As a result, the FRA promulgated several regulations that provide guidelines on how and when the horn is to be sounded. For example, in the absence of a state regulation, a horn must be sounded starting at a position no greater than ¼ mile away from the grade crossing. Furthermore, the railroad must place a whistle board (a wayside sign telling the conductor to begin sounding a horn) at a location such that a train traveling at the maximum speed will begin sounding its horn 15 seconds before the crossing, or the railroad must ensure by other methods that the horn is sounded no less than 15 seconds, but not more than 20 seconds, before the locomotive enters the grade crossing. The rule does not supersede any state regulations currently in place until a change in the maximum allowable speed is made, at which time the requirements of the FRA regulations become effective. However, accurately determining the timing for sounding a warning signal is difficult and time consuming.

Even if a device, such as a whistle board, is present to inform an engineer as to the precise location to begin sounding a train horn, the position of the whistle board is based on the train traveling at a predetermined fixed speed at that location. However, when a train is traveling at a speed that is different, the engineer should not sound the horn at the whistle board, but rather the engineer is responsible for calculating the proper time to sound the horn based on the current speed of the train and the distance from the crossing. As a result, having the engineer determine an appropriate wait time for different train speeds prior to sounding the horn is both time consuming and may be inaccurate.

### BRIEF DESCRIPTION OF THE INVENTION

In one embodiment, a method for automatically sounding a vehicle warning is provided. The method includes determining when the vehicle is within a predetermined distance to a warning area, and determining a speed of approach of the vehicle to the warning area. The method also includes determining an initiation point to activate the vehicle warning based on the speed of approach of the vehicle, and sounding the vehicle warning at the initiation point.

In another embodiment, a system for automatically sounding a vehicle warning is provided. The system includes a warning device configured to determine when a vehicle is within a predetermined distance to a warning area. The system also includes a signaling system that is activated when the vehicle is within the predetermined distance. The signaling system configured to determine a speed of approach of the vehicle to the warning area, determine an initiation point to activate the vehicle warning based on the speed of approach of the vehicle, and sound the vehicle warning at the initiation point.

### BRIEF DESCRIPTION OF THE DRAWINGS

FIG. 1 is a block diagram of an exemplary vehicle control system;

FIG. 2 is a flow chart of an exemplary method for controlling a warning signal using the vehicle control system shown in FIG. 1;

FIG. 3 is a block diagram of an exemplary embodiment of the vehicle control system shown in FIG. 1; and

FIGS. 4A, 4B, 4C, and 4D are timing diagrams of exemplary warning signal sequences that may be used by the vehicle control system shown in FIG. 3.

### DETAILED DESCRIPTION OF THE INVENTION

Many specific details of certain embodiments of the invention are set forth in the following description in order to provide a thorough understanding of such embodiments. One skilled in the art, however, will understand that the present invention may have additional embodiments, or that the present invention may be practiced without several of the details described in the following description.

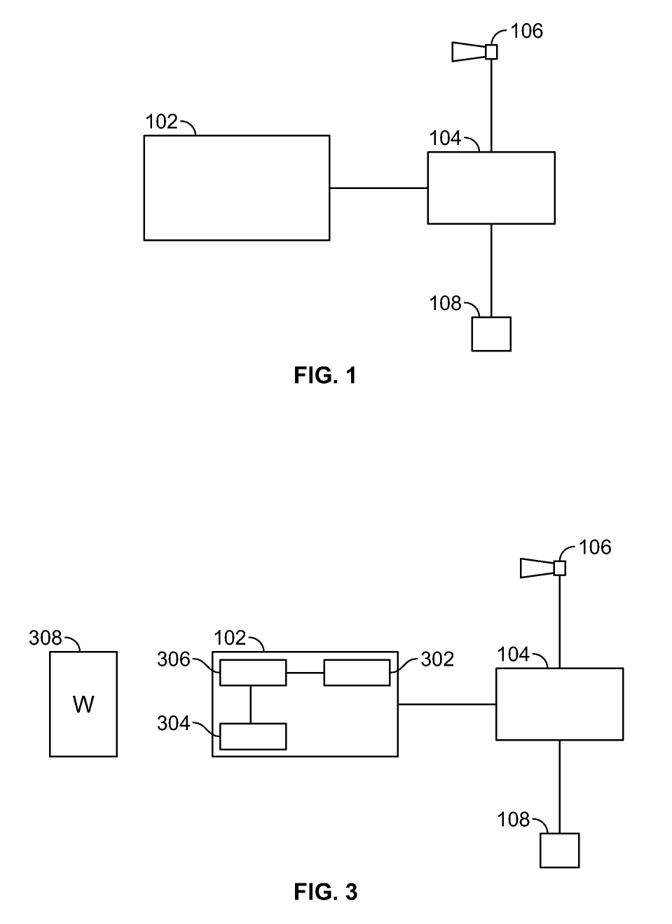

FIG. 1 is a block diagram of an exemplary embodiment of a vehicle control system 100 that may be used with a locomotive to activate a warning signal. Although, control system 100 is described with respect to a locomotive, as will be appreciated by one of ordinary skill in the art, control system may be used with any vehicle that is required to activate a warning signal while traveling through a warning area. Moreover, although control system 100 is described with respect to activating a warning signal, as will be appreciated by one of ordinary skill in the art, control system may be used to activate any function of a vehicle.

In the exemplary embodiment, vehicle control system 100 includes a warning device 102, a signaling system 104, and a horn 106. Further, in the exemplary embodiment, control system 100 also includes at least one indicator 108 such as, but not limited to, a light, a speaker, and/or a seat vibrator. Specifically, in the exemplary embodiment, warning device 102, signaling system 104, horn 106, and indicator 108 are each electronically coupled. However, as will be appreciated by one of ordinary skill in the art, any of warning device 102, signaling system 104, horn 106, and/or indicator 108 may have any configuration that enables control system 100 to operate as described herein.

In the exemplary embodiment, warning device 102 is at least one of, but is not limited to being, an imaging device, a bar code scanner, and/or a radio-frequency tag. In an alternative embodiment, control system 100 does not include warning device 102, but rather, a whistle post is positioned along a track upon which the locomotive is traveling. In the exemplary embodiment, signaling system 104 also includes a processor 110. As used herein, the term “processor” is not limited to just those integrated circuits referred to in the art as processors, but broadly refers to computers, processors, microcontrollers, microcomputers, programmable logic controllers, application specific integrated circuits, and other programmable circuits. The processor may be part of a computer that may include a device, such as, a floppy disk drive or compact disc-read-only memory (CD-ROM) drive, for reading data from a computer-readable medium, such as a floppy disk, a CD-ROM, a magneto-optical disk (MOD), or a digital versatile disc (DVD).

During operation, in the exemplary embodiment, warning device 102 provides an indication when the locomotive is within a predetermined distance to a warning area. Specifically, signaling system 104 activates when the locomotive is within the predetermined distance of device 102. In one embodiment, warning device 102 activates signaling system 104. In an alternative embodiment, an engineer is signaled by indicator 108 visually, aurally, and/or tactilely to activate signaling system 104. Upon activation, and as described in more detail below, signaling system 104 determines when horn 106 should sound.

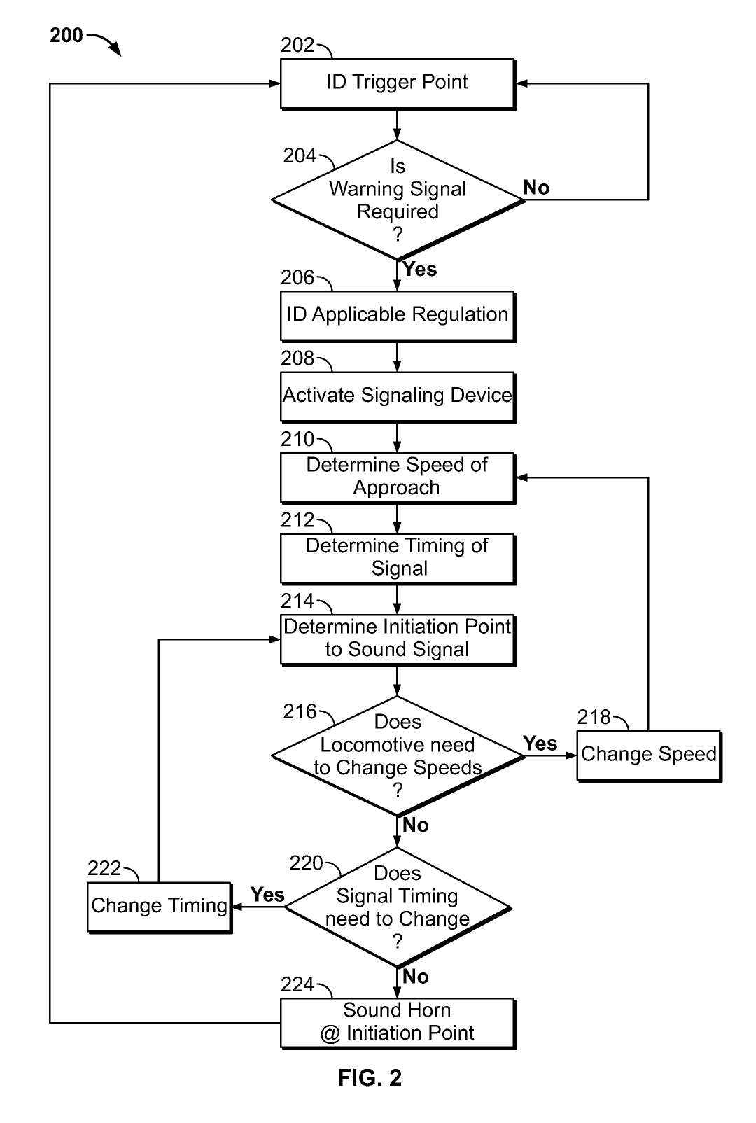

FIG. 2 is a flow chart of an exemplary method 200 for use in controlling a warning signal using vehicle control system 100. In the exemplary embodiment, the method 200 includes identifying 202 a trigger point that indicates when to activate signaling device 104. In one embodiment, the trigger point is identified by warning device 102. For example, the trigger point may include a radio-frequency tag, a readable bar code that is recognized by a bar code scanner, and/or an image marker that is viewed by an imaging device. In another embodiment, the trigger point includes a whistle post or other indicator of a road crossing that is designed to be viewed by the engineer.

Vehicles, such as a locomotive for example, are required to comply with local, state, and or federal regulations with respect to sounding their horn when approaching a road crossing. Accordingly, whether a warning signal is required is determined 204 and if not required, then method 200 loops back to identify 202 the next whistle board. A warning signal may not be required in certain instances even though the vehicle has passed a marker. For example, regulations may prohibit a warning signal at certain times of the day. Additionally, a warning signal may not be required during switching operations when the vehicle such as a locomotive may pass a marker several times at a low speed to accomplish a switching operation. Moreover, a warning signal may not be required at each crossing when a plurality of crossings are situated in close proximity.

If a warning signal is required, and because regulations vary depending on the particular crossing being approached, the applicable regulation associated with the identified marker is determined 206. Next, signaling system 104 is activated 208. For example, in one embodiment, warning device automatically activates signaling system 104 upon determining that a warning signal is required. In another embodiment, warning device activates indicator 108 to alert the engineer to manually activate signaling system 104. Specifically, indicator 108 alerts the engineer using at least one of a visual, aural, and tactile indication. In a further embodiment, the engineer recognizes the trigger point, manually determines whether a warning signal is required, and then activates signaling system 104. In another embodiment, as the locomotive passes the trigger point, a local system transmits a signal that activates signaling system 104. In yet another embodiment, as the locomotive passes the trigger point, a database of predetermined locomotive locations transmits a signal that activates signaling system 104.

Upon activation, signaling system 104 begins a warning signal sequence. Specifically, signaling system 104 first determines 210 a speed of the vehicle. Further, in one embodiment, the speed is determined using the imaging device as described in further detail below. In alternative embodiments, the speed of the vehicle may be determined using tachometers connected to the wheels or other members of the drive train, electrical tachometers receiving signals from the vehicle engine, global positioning satellite systems, and/or other speed determining subsystems.

Next, signaling system 104 determines 212 a timing of the warning signal based on the appropriate regulations. In particular, signaling system 104 determines how long the warning signal should sound. For example, in one embodiment, the applicable regulation may require horn 106 to sound for 15-20 seconds prior to the vehicle entering a crossing. In another embodiment, signaling system 104 may determine a number of blasts that should sound and an appropriate length of each blast. Based on the required timing of the blasts and the speed of the vehicle, an initiation point for sounding horn 106 is determined 214. Specifically, the initiation point is determined to ensure that the horn sounds for the applicable time prior to the vehicle entering the crossing. Further, in one embodiment, the initiation point is determined to enable the horn to sound prior to the vehicle entering the crossing and to ensure it sounds while the vehicle travels through the crossing.

In the exemplary embodiment, signaling system 104 determines 216 if the locomotive is required to change speeds. For example, if the speed of the locomotive and the location of the initiation point would cause horn 106 to sound after the locomotive has passed through the warning area, signaling system 104 changes 218 the speed of the locomotive by increasing its speed. Alternatively, if the speed of the locomotive and the location of the initiation point would cause horn 106 to stop sounding before the locomotive has passed through the warning area, signaling system 104 changes 218 the speed of the locomotive by decreasing its speed. After the locomotive changes speeds, signaling system 104 again determines 210 the speed of the locomotive an repeats steps 212, 214, and 216.

Further, in the exemplary embodiment, signaling system 104 determines 220 if the length of warning signal needs to be changed. Specifically, the regulations may dictate that the length of the warning signal should be between 15 and 20 seconds. Accordingly, the length of the signal may be changed within this range. For example, if the speed of the locomotive, the location of the initiation point, and the timing of the signal would cause horn 106 to sound after the locomotive has passed through the warning area, signaling system 104 changes 222 the timing of the signal by decreasing the timing. Alternatively, if the speed of the locomotive, the location of the initiation point, and the timing of the signal would cause horn 106 to stop sounding before the locomotive has passed through the warning area, signaling system 104 changes 222 the timing of the signal by increasing the timing. After signaling system 104 changes the timing of the signal, system 104 repeats the determination 214 of the initiation point of the signal and repeats step 218.

When the locomotive passes the initiation point, horn 106 is sounded 224. In one embodiment, horn 106 is automatically sounded by signaling system 104 when the locomotive passes the initiation point. In another embodiment, indicator 108 alerts the engineer that the initiation point is approaching. Specifically, indicator 108 alerts the engineer using, for example, at least one of a visual, aural, and tactile indication. In one embodiment, horn 224 is sounded for the applicable time as the locomotive approaches the crossing, in accordance with the applicable regulation. In another embodiment, horn 224 is sounded for the applicable time as the locomotive approaches the crossing and as the locomotive travels through the crossing, in accordance with the applicable regulation. After the warning signal sequence is complete and horn 224 is sounded, control system 100 is reset to identify the next trigger point.

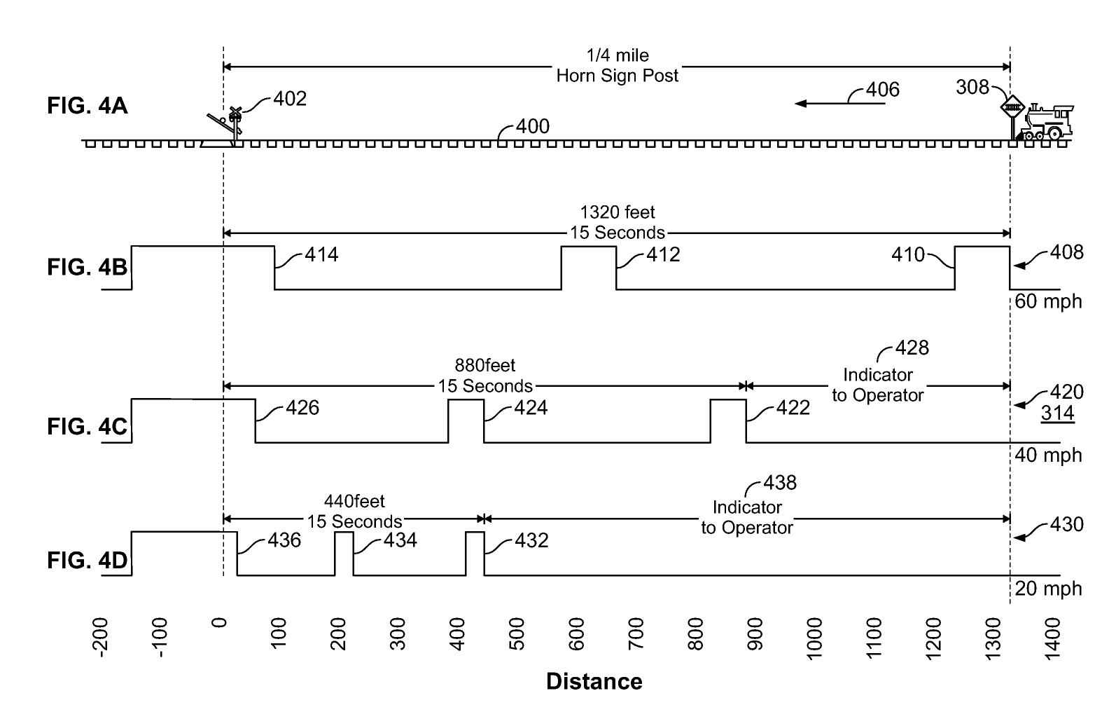

FIG. 3 is a block diagram of an exemplary embodiment of vehicle control system 100. Specifically, FIG. 3 illustrates a control system 300 that includes an imaging system as its warning device 102. As will be appreciated by one of ordinary skill in the art, elements of control system 300 that are the same as elements of control system 100, shown in FIG. 1, are identified using the same reference numerals. FIGS. 4A, 4B, 4C, and 4D illustrate timing diagrams of exemplary warning signal sequences that may be used by control system 300. Although FIGS. 4A-4D are described with respect to control system 300, as will be appreciated by one of ordinary skill in the art, the timing diagrams illustrated in FIGS. 4A-4D, with modification, can also apply to any embodiment of control system 100.

In the exemplary embodiment, warning device 102 includes a data preservation programming and management system 302, an imaging device 304, and an image processor 306. Data preservation programming and management system 302 is electronically coupled to signaling system 104. Imaging device 304 is typically aimed forwardly towards the direction of travel of the vehicle. Further, in one embodiment, data preservation programming and management system 302 is communicatively coupled to an image processor 306. Image processor 306 may be a stand alone unit, or alternatively may be incorporated as a function of data preservation programming and management system 302. Image processor 306 receives image data from imaging device 304, through data preservation programming and management system 302, and/or to receives image data directly from imaging device 304.

In operation, imaging device 304 captures image data of wayside objects, such as whistle board 308 for example, and transmits such images to image processor 306 or data preservation programming and management system 302. Image processor is programmed to compare the captured image to an image of a known object stored in data preservation programming and management system 302 to identify the objects in the captured image. Objects may be identified, for example, using symbols on the object, by an outline of the object, by a color scheme associated with the object, other image processing methodologies, or combinations thereof. For example, a whistle board 308 may be identified using an outline of its shape, by the symbol “W” appearing on a surface of whistle board 308, or through a combination of these or other features. When a match is made between an object in a captured image and an object in a stored image, image processor 306 utilizes the identification of the object in a logic circuit to activate signaling system 104.

In one embodiment, image processor 306 also determines other parameters from received images, such as, but not limited to, a speed of the locomotive as it passes an object. In such a case, the object does not need to be identified; but rather the object merely needs to appear in order in sequential images that are captured at predetermined time intervals. For example, image processor 306 selects a pattern of a first image that is generated at a first time and locates the same pattern in a second subsequent image that is generated at a second time. Image processor determines a distance traveled by determining elapsed time and/or differences between the first and second times. Image processor 306 then determines a speed of the locomotive using the determined distance and also utilizing the physical differences in the captured images.

In another embodiment, image processor 306 determines any weather and or lighting conditions that may affect a requirement for sounding of the warning signal. For example, some warning signal sequences may be necessary in various weather conditions such as fog, smoke, darkness, or blizzard conditions that may affect visibility.

FIG. 4A is a side view of a section of track 400 that includes warning area 402, such as a road crossing. In the exemplary embodiment, a whistle board 308 is positioned approximately one quarter mile away from warning area 402. In FIG. 4A, direction 406 indicates the direction of travel of the locomotive approaching the warning area 402.

In use, image processor 306 is programmed to automatically identify a passing object, such as the whistle board 308, and to automatically calculate the speed of the locomotive as the locomotive passes the whistle board 308. Since, the distance between the whistle board 308 and the warning area 402 is generally set by federal guidelines, programming and management system 302 utilizes the information received from image processor 306 used in identifying the whistle board 308, and the predetermined distance between the whistle board 308 and the warning area 402, to generate a warning signal sequence.

As discussed above, under certain federal and state guidelines, a locomotive engineer may be required to initiate a warning signal, e.g. sound horn 106, when the locomotive passes whistle board 308. However, the position of the whistle board 308 is based on the train traveling at the maximum speed at that location. However, when a train is traveling at a speed that is less than the maximum speed, programming and management system 302 is configured to generate a warning signal sequence based on the speed of the locomotive as the locomotive passes whistle board 308.

FIG. 4B is an exemplary timing diagram for a first exemplary warning signal sequence 408 generated by programming and management system 302 when the locomotive is traveling at approximately sixty miles per hour. In such an embodiment, sequence 408 includes two short blasts 410 and 412 and a long blast 414. The length of each blast may be determined by elapsed time, or may be determined by a change in distance from the start of each blast to the finish of each blast. Additionally, the timing of sequence 408 may be determined by elapsed time, or may be determined by a change in distance from the start of each blast to the finish of each blast. Because of the speed of the locomotive and the requirements of timing the warning signal by regulation, there is no time delay between the locomotive passing whistle board 308 and the initiation of short blast 410. Specifically, because, in this example, the locomotive is traveling at approximately sixty miles per hour as determined by programming and management system 302, the whistle board 308 is positioned approximately one-quarter of a mile from warning area 402 by regulation, and the horn 104 must be sounded for fifteen seconds from the locomotive entering warning area 402, programming and management system 302 calculates that the warning signal sequence 408 should be initiated when the locomotive passes whistle board 308 as identified by image processor 306.

FIG. 4C is an exemplary timing diagram for a second warning signal sequence 420 generated when the locomotive is traveling at approximately forty miles per hour. Sequence 420 includes two short blasts 422 and 424 and a long blast 426. Because of the speed of the locomotive and the requirements of timing the warning signal by regulation, there is a time delay 428 between the locomotive passing whistle board 308 and the initiation of short blast 422. The length of time delay 428 ensures that the start of sequence 420 does not occur prior to the regulated maximum time prior to warning area 402. In this case, since the speed of the locomotive is approximately forty miles per hours as determined by programming and management system 302, the warning signal sequence 420 will be activated when the locomotive is approximately 880 feet from warning area 402 such that horn 104 is activated fifteen seconds prior to the locomotive entering warning area 402.

FIG. 4D is an exemplary timing diagram for a third warning signal sequence 430 generated when the locomotive is traveling at approximately twenty miles per hour. Sequence 430 includes two short blasts 432 and 434 and a long blast 436. Because of the speed of the locomotive and the requirements of timing the warning signal by regulation, there is a time delay 438 between the locomotive passing whistle board 308 and the initiation of short blast 432. The length of time delay 438 ensures that the start of sequence 430 does not occur prior to the regulated maximum time prior to warning area 402. Although the blasts in FIGS. 4B, 4C, and 4D appear to have differing lengths, the blasts in FIGS. 4B, 4C, and 4D have the same length. The apparent difference in length is due to the scale of the figures being in distance rather than time.

The foregoing description of the exemplary embodiments of the invention are described for the purposes of illustration and are not intended to be exhaustive or limiting to the precise embodiments disclosed. Many modifications and variations are possible in light of the above teaching. It is intended that the scope of the invention be limited not with this detailed description, but rather by the claims appended hereto.

In one embodiment, a method for automatically sounding a vehicle warning is provided. The method includes determining when the vehicle is within a predetermined distance to a warning area, and determining a speed of approach of the vehicle to the warning area. The method also includes determining an initiation point to activate the vehicle warning based on the speed of approach of the vehicle, and sounding the vehicle warning at the initiation point.

In the exemplary embodiment, the method also includes activating a signaling system when the vehicle is within the predetermined distance. The signaling system is configured to determine the speed of approach, determine the initiation point, and sound the vehicle warning. In one embodiment, the signaling system is manually activated when the vehicle passes a whistle post positioned at the predetermined distance from the warning area. In another embodiment, the signaling system is activated when at least one of an imaging device, a bar code scanner, and a radio frequency tag indicates that the vehicle is within the predetermined distance to the warning area. For example, in one embodiment, the image processor views the path of the vehicle in the direction of travel to identify an image marker identifying the predetermined distance to the warning area. Further, sequential images of the image marker are generated to determine the speed of the vehicle.

In one embodiment, the method also includes generating at least one of a visual, aural, and a tactile indication when the vehicle is within the predetermined distance. Further, in the exemplary embodiment, the vehicle is a locomotive and the method includes sounding the vehicle warning as a locomotive approaches and crosses a railroad crossing. Moreover, in one embodiment, the method includes identifying an appropriate regulation governing the operation of the vehicle warning, and generating the vehicle warning based on the regulation identified. In such an embodiment, the method also includes indicating a change in the speed of the vehicle that is necessary to generate the vehicle warning based on the identified regulation.

The above-described methods and systems for automatically sounding a vehicle warning are cost-effective and highly reliable. The system permits automatically determining the boundaries of area when a warning signal is required to be sounded by regulation, alerting the user to the approaching need to sound the warning signal, and in one embodiment, to sound the warning signal in accordance with the regulatory mandate without user input. Accordingly, the methods and systems described herein facilitate operation of data recorders in a cost-effective and reliable manner.

Exemplary embodiments of systems and methods for automatically activating train warning devices are described above in detail. The systems and methods illustrated are not limited to the specific embodiments described herein, but rather, components of the system may be utilized independently and separately from other components described herein. Further, steps described in the method may be utilized independently and separately from other steps described herein.

While the invention has been described in terms of various specific embodiments, those skilled in the art will recognize that the invention can be practiced with modification within the spirit and scope of the claims.

What is claimed is:

1. A method for automatically sounding a vehicle warning, said method comprising:
determining when the vehicle is within a predetermined distance to a warning area;
determining a speed of approach of the vehicle to the warning area;
determining an initiation point to activate the vehicle warning based on the speed of approach of the vehicle; and
sounding the vehicle warning at the initiation point.

2. A system in accordance with claim 1 further comprising activating a signaling system when the vehicle is within the predetermined distance, wherein the signaling system is configured to determine the speed of approach, determine the initiation point, and sound the vehicle warning.

3. A method in accordance with claim 2 further comprising manually activating the signaling system when the vehicle passes a whistle post positioned at the predetermined distance from the warning area.

4. A method in accordance with claim 1 wherein said indicating when a vehicle is within a predetermined distance to a warning area further comprises indicating that the vehicle is within the predetermined distance using at least one of an imaging device, a bar code scanner, and a radio frequency tag.

5. A method in accordance with claim 4 wherein said indicating that the vehicle is within the predetermined distance with an image processor further comprises viewing the path of the vehicle in the direction of travel to identify an image marker identifying the predetermined distance to the warning area.

6. A method in accordance with claim 5 further comprising generating sequential images of the image marker to determine the speed of the vehicle.

7. A method in accordance with claim 1 further comprising generating at least one of a visual, aural, and a tactile indication when the vehicle is within the predetermined distance.

8. A method in accordance with claim 1 wherein said sounding the vehicle warning at the initiation point further comprises sounding the vehicle warning as a locomotive approaches and crosses a railroad crossing.

9. A method in accordance with claim 1 further comprising:
identifying an appropriate regulation governing the operation of the vehicle warning; and
generating the vehicle warning based on the regulation identified.

10. A method in accordance with claim 9 further comprising indicating a change in the speed of the vehicle that is necessary to generate the vehicle warning based on the identified regulation.

11. A system for automatically sounding a vehicle warning, said system comprising:
a warning device configured to determine when a vehicle is within a predetermined distance to a warning area;
a signaling system that is activated when the vehicle is within the predetermined distance, said signaling system configured to:
determine a speed of approach of the vehicle to the warning area,
determine an initiation point to activate the vehicle warning based on the speed of approach of the vehicle, and
sound the vehicle warning at the initiation point.

12. A system in accordance with claim 11 wherein said warning device activates said signaling system when the vehicle is within the predetermined distance from the warning area.

13. A system in accordance with claim 11 wherein said warning device comprises at least one of an imaging device, a bar code scanner, and a radio frequency tag.

14. A system in accordance with claim 13 wherein said image processor is configured to view the path of the vehicle in the direction of travel to identify an image marker identifying the predetermined distance to the warning area.

15. A system in accordance with claim 14 wherein said image processor is further programmed to generate sequential images of the image marker to determine the speed of the vehicle.

16. A system in accordance with claim 11 wherein said warning device comprises a whistle post positioned at the predetermined distance, said signaling system activated when the vehicle passes the whistle post.

17. A system in accordance with claim 11 wherein said warning device is further configured to generate at least one of a visual, aural, and a tactile indication when the vehicle is within the predetermined distance.

18. A system in accordance with claim 11 wherein said signaling system is further configured to sound the vehicle warning as a locomotive approaches and crosses a railroad crossing.

19. A system in accordance with claim 11 wherein said signaling system is further configured to:
identify an appropriate regulation governing the operation of the vehicle warning; and
generate the vehicle warning based on the regulation identified.

20. A system in accordance with claim 19 wherein said signaling system is further configured to indicate a change in the speed of the vehicle that is necessary to generate the vehicle warning based on the identified regulation.
